(19) United States
(12) Patent Application Publication
(10) Pub. No.: US 2010/0221599 A1
(43) Pub. Date: Sep. 2, 2010

(54) AA CELL BATTERY

(76) Inventor: Yasushi Sumihiro, Hyogo (JP)

Correspondence Address: MCDERMOTT WILL & EMERY LLP, 600 13TH STREET, NW, WASHINGTON, DC, 20005-3096, US

(21) Appl. No.: 12/160,845

(22) PCT Filed: Jan. 18, 2008
(86) PCT No.: PCT/JP2008/050645

§ 371 Date: Jul. 14, 2008

(30) Foreign Application Priority Data
May 15, 2007 (JP) 2007-128883

(51) Int. Cl. H01M 2/08

(52) U.S. Cl. 429/174

(57) ABSTRACT

Electric power elements (positive and negative electrode mixtures 2 and 3) are included in a cylindrical battery case 1 with a base also serving as one electrode terminal (positive electrode terminal), an opening portion of the battery case 1 is sealed with an external terminal plate 7 serving as the other electrode terminal (negative electrode terminal) with an insulating sealing body 5 interposed therebetween. An outer surface of the battery case 1 is coated with an insulating exterior label 8. The opening portion of the battery case 1 is sealed with the external terminal plate 7 by inwardly bending an opening edge portion of the battery case 1 into an arc shape to crimp the battery. An arc radius of the crimped portion 1a is in a range from 0.5 mm to 1.5 mm. An outer diameter of the battery is in a range from 14.20 mm to 14.35 mm.

### TECHNICAL FIELD

The present invention relates to AA cell batteries whose shape is defined by the JIS standard (R6 by the IEC standard and AA by the ANSI standard).

### BACKGROUND ART

Presently, as AA cell batteries, alkaline dry batteries, manganese dry batteries and the like are mainly manufactured and sold. Batteries of these kinds are widely used as main power supply for daily commodities, toys, hobby goods, game instruments, portable music players, electronic devices and the like, and are desired to have a long life when being used in a device.

To achieve a long driving time of a device, a capacity of a battery has to be increased. To achieve this, a capacity of a battery is increased by increasing a size of a battery within the range defined by the JIS standard as well as by increasing a capacity of positive and negative materials which are electric power generation elements of a battery (see, for example, Patent Document 1). Specifically, in an AA cell battery whose shape is defined to be a long and thin cylindrical shape by the JIS standard, the outer diameter of the battery largely contributes to increase in battery capacity.

To increase a battery volume, it is also effective to reduce a thickness of a battery case 101 as well as to increase the outer diameter of the battery.

FIG. 2 is a cross-sectional view of a typical AA cell battery 100 having a cylindrical shape. An outer diameter of the AA cell battery 100 is determined by an outer diameter R of a battery case 101 in which an electric power generation element 102 is included and a thickness T of an exterior label 103 for covering an outer surface of the battery case 1 and ensuring insulation. The AA cell battery 100 has a maximum outer diameter in part of the AA cell battery 100 in which the exterior label 103 overlaps. Specifically, a dimension (R+3T) obtained by adding a thickness 3T of three layers of the exterior label 103 to the outer diameter R of the battery case 101 is the maximum outer diameter (which will be merely referred to as “outer diameter”) of the AA cell battery 100. The outer diameter of an AA cell battery defined by the JIS standard is 14.5 mm at a maximum.

However, in actual situations, the outer diameter of known AA cell batteries is 14.0-14.2 mm for alkaline dry batteries and 13.8-14.1 mm for manganese dry batteries. Patent Document 1: Japanese Translation of PCT International Application No. 2002-532851

### DISCLOSURE OF THE INVENTION

### Problems that the Invention is to Solve

The present inventor formed pin gauges (each corresponding to a pseudo AA cell battery) so that a total height of each of the pin gauges was 45 mm and respective outer diameters of the pin gauges differ by 0.05 mm in the range from 14.20 mm to a 14.50 mm which is a maximum outer diameter defined by the JIS standard and loaded in devices in which an AA cell battery was used as a power supply. Then, the inventor examined inconveniences arising in loading the pin gauges. In the examination, about 500 items of devices including daily commodities, toys, hobby goods, game instruments, portable music players and electronic devices were used. Note that the AA cell batteries were loaded in the devices in largely two different manners. That is, as shown in FIG. 3(a), an AA cell battery 100 was loaded in a battery loading section 201 of a device 200 such that a body side of the AA cell battery 100 went into in the battery loading section 201 first and then a lid 202 was closed. Also, as shown in FIG. 3(b), an AA cell battery 100 was inserted in a cylindrical battery loading section 201 such that a terminal side of the AA cell battery 100 went into the battery loading section 201 first and then a lid 202 was closed.

As a result of the examination, in about 5% of all the devices, pseudo AA cell battery having an outer diameter of 14.30 mm or more had to be forcedly pressed into a battery loading section of a device when the battery was loaded or a lid 202 was hard to be closed in the manner shown in FIG. 3(a). Also, when batteries were loaded in the manner of FIG. 3(b), pseudo batteries had to be forcedly pressed in a battery loading section and could not be smoothly loaded. Furthermore, in about 2% of all the devices, when pseudo AA cell batteries having an outer diameter of 14.35 mm or more was loaded in the manner of FIG. 3(a), the lid could not be closed, and when a pseudo battery AA cell batteries having an outer diameter of 14.35 mm or more was loaded in the manner of FIG. 3(b), the battery could not be loaded.

The above-described examination was conducted using pseudo AA cell batteries. Assume that actual AA cell batteries are used in the examination. Since an exterior label is provided to cover an outer surface of each battery for the purpose of ensuring insulation, the exterior label might be damaged to lose insulation when the battery is forcedly located in the device, so that the battery might be short-circuited in a device. Specifically, assume that part of the exterior label located around a crimped portion of a battery case is broken and the battery case is exposed. Because the part of the exterior label around the crimped portion is close to an external terminal plate (also serving as one electrode terminal) for sealing an opening portion of the battery case, it is highly possible that the battery case (also serving as the other electrode terminal) and the external terminal plate are short-circuited.

In view of the above-described points, the present invention has been devised and it is therefore an object of the present invention to provide an AA cell battery which is practically loadable in an electronic device, is capable of maintaining safety and has an increased capacity with an increased battery volume.

### Solution to the Problems

To achieve the above-described object, an AA cell battery according to the present invention is an AA cell battery in which electric power elements are included in a cylindrical battery case with a base, an opening portion of the battery case is sealed with an external terminal plate with an insulating sealing body interposed therebetween, and an outer surface of the battery case is coated with an insulating exterior label, and is characterized in that a thickness of the exterior label is in a range from 0.05 mm to 0.10 mm and a maximum outer diameter of the battery is in a range from 14.20 mm to 14.35 mm.

In one preferred embodiment of the present invention, the opening portion of the battery case is sealed with the external terminal plate by inwardly bending an opening edge portion of the battery case into an arc shape to crimp the battery, and a radius of an arc of the crimped portion is in a range from 0.5 mm to 1.5 mm.

### EFFECTS OF THE INVENTION

According to the present invention, as has been described, by setting the thickness of an exterior label to be in the range from 0.05 mm to 0.10 mm and the maximum outer diameter of a battery to be in the range from 14.20 mm to 14.35 mm, an AA cell battery which is practically loadable in an electronic device and has an increased capacity can be achieved.

Furthermore, by setting the radius of a crimped portion to be in the range from 0.5 mm to 1.5 mm, damages on the external label caused in loading a battery in a device can be prevented, so that an AA cell battery which is capable of maintaining safety and has an increased capacity can be achieved.

### BRIEF DESCRIPTION OF THE DRAWINGS

FIGS. 1(a) and 1(b) are schematic views illustrating a configuration of an AA cell battery according to an embodiment of the present invention. FIG. 1(a) is a half sectional view of the battery and FIG. 1(b) is a partial cross-sectional view illustrating a crimped portion.

FIG. 2 is a cross-sectional view of a known AA cell battery.

FIGS. 3(a) and 3(b) are illustrations of devices in which the known AA cell battery is loaded. FIG. 3(a) illustrates a configuration of a device in which the battery is loaded such that a body side of the battery goes into a battery loading section first and FIG. 3(b) illustrates a configuration of a device in which the battery is inserted into a battery loading section such that a terminal side of the battery goes into the battery loading section first.

### EXPLANATION OF REFERENCE NUMERALS

1 Battery case
1a Crimped portion
2 Positive electrode mixture
3 Gelled negative electrode
4 Separator
5 Sealing body
6 Negative electrode current collector
7 External terminal plate
8 Exterior label
9 Assembled sealing body

### BEST MODE FOR CARRYING OUT THE INVENTION

Hereafter, embodiments of the present invention will be described with reference to the accompanying drawings. In the drawings, for the purpose of simplification of description, each component having substantially the same function is identified by the same reference numeral. Note that the present invention is not limited to the following embodiments.

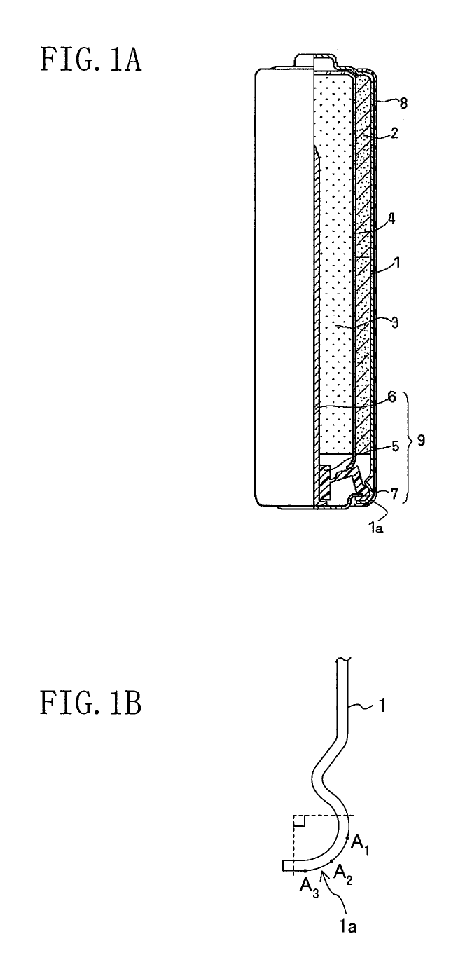

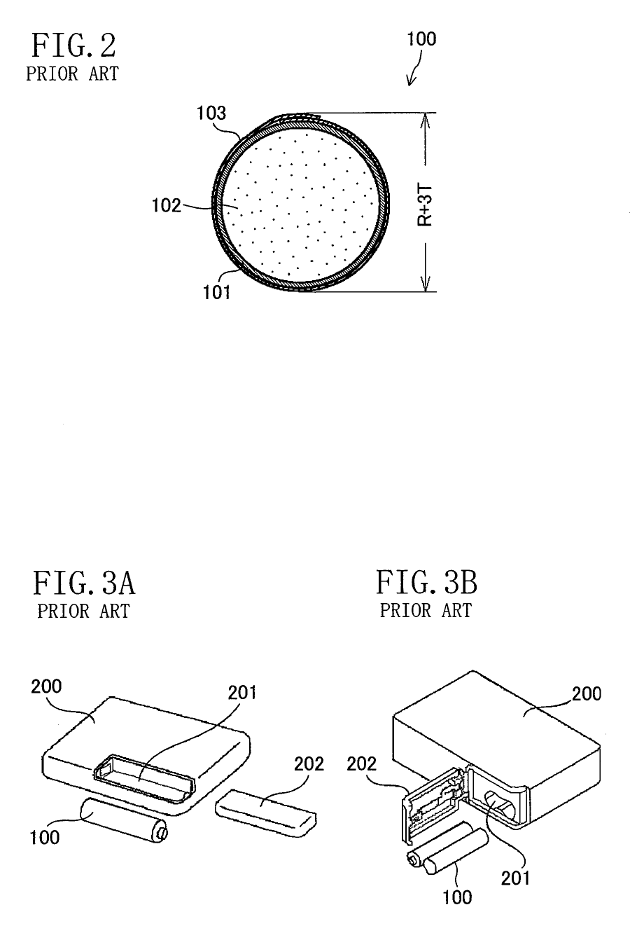

FIG. 1(a) is a half sectional view schematically illustrating the configuration of an AA alkaline dry battery according to an embodiment of the present invention. FIG. 1(b) is an enlarged, partial cross-sectional view illustrating a crimped portion. Note that the battery of this embodiment is an AA cell battery whose outer diameter is defined by the JIS standard (LR6 by the IEC standard and AA by the ANSI standard).

As shown in FIG. 1(a), electric power generation elements (i.e., a positive electrode mixture 2, a negative electrode mixture 3 and the like) of the battery are included in a battery case 1 which has a cylindrical shape with a base and also serves as one electrode terminal (for example, a positive electrode terminal), and an opening portion of the battery case 1 is sealed with an external terminal plate 7, which serves as the other electrode terminal (for example, a negative electrode terminal), with an insulating sealing body 5 interposed therebetween. An outer surface of the battery case 1 is covered by an insulating exterior label 8. The opening portion of the battery case 1 is sealed with the external terminal plate 7 by inwardly bending an opening edge portion of the battery case 1 into an arc shape to crimp the battery. In this case, an arc of a crimped portion 1a has a radius in the range from 0.5 mm to 1.5 mm and the battery has an outer diameter (R+3T; where R is an outer diameter of the battery case 1 and T is a thickness of the exterior label 8) in the range from 14.20 mm to 14.35 mm.

Note that the arc of the crimped portion 1a does not have to have a certain curvature. A “radius of an arc” in the present invention means, as shown in FIG. 1(b), an average value of a curvature radius at arbitrary three points A1, A2 and A3 (or more points) on an arc defined by an interior angle of 90°.

The battery case 1 is formed, for example, by pressing a nickel plated steel sheet so that the nickel plated steel sheet has predetermined dimensions and shape. In the battery case 1, the positive electrode mixture 2 formed in the shape of a hollow cylinder is included so as to touch in the battery case 1. The gelled negative electrode 3 is provided in a hollow portion of the positive electrode mixture 2 with a cylindrical separator 4 with a base interposed therebetween. After accommodating the electric power generation elements such as the positive electrode mixture 2, the gelled negative electrode 3 and the like in the battery case 1, an assembled sealing body 9 which is a united body of the nail shaped negative electrode current collector 6, the external terminal 7 electrically connected to the negative electrode current collector 6, and a resin sealing body 5 is provided and then the opening portion of the battery case 1 is sealed with the crimped portion 1a, i.e., the opening edge portion of the battery case 1 inwardly bent into an arc shape.

A base material of the exterior label 8 is a heat-shrinkable resin film such as polyethylene, polyvinyl chloride, polystyrene, polyethylene terephthalate or the like. Moreover, if a protective layer is provided on the surface of the exterior label 8 by coating it with varnish, lacquer, invisible ink or the like which provides wear resistance and lubricating property, the battery can be smoothly loaded in a device. The protective layer is preferably formed of an ultraviolet cure material because coating can be easily performed. Moreover, the protective film may be formed by laminating an invisible film thereon. The exterior label 8 is put on the outer surface of the battery case 1 so as to wind around the battery case 1 and to be adhered thereon and then the entire exterior label 8 can be heat-shrunken by heat wave, thereby making the exterior label 8 in close contact with the battery case 1. Note that when edge portions of the exterior label 8 are adhered together on the outer surface of the battery case 1, a length of an overlapping portion on the outer surface is set to be, for example, 5 mm or less. Thus, the battery can be smoothly loaded in a device. As another alternative, the battery case 1 may be inserted in the exterior label 8 formed into a tube shape and be heat-shrunken, thereby making the exterior label 8 in a close contact with the battery case 1.

TABLE 1

| | AA cell alkaline dry battery | |
|---|---|---|
| | | The number of batteries |
| | Radius of arc of crimped | of which the exterior |
| | portion (mm) | label is broken |
| Working Example 1 | 0.4 | 5 |
| Working Example 2 | 0.5 | 0 |
| Working Example 3 | 1.0 | 0 |
| Working Example 4 | 1.5 | 0 |

Table 1 shows the number of batteries of which the exterior label 8 was broken when each of the battery cases 1 of which respective opening portions were sealed by crimping such that the respective crimped portions 1a have different arc radiuses was loaded in a device 200. In this examination, an inner diameter of a tube shaped battery loading section 201 in which each battery was loaded was 14.37 mm, an outer diameter R of each of the battery cases 1 was 14.20 mm, and a thickness T of each of the exterior labels 8 was 0.05 mm. Respective radiuses of the cylindrical crimped portions 1a were 0.4 mm, 0.5 mm, 1.0 mm and 1.5 mm (Working Examples 1 through 4). Then, an examination on whether or not the exterior label is broken when the battery case is loaded was conducted to 100 batteries for each of Working Examples 1 through 4.

As seen from Table 1, in the batteries having the crimped portion 1a with an arc radius of 0.5 mm or more (Working Examples 2 through 4), the exterior label was not broken. Only in the batteries having the crimped portion 1a with an arc radius of 0.4 mm (Working Example 1), the exterior label 8 was broken. This is possibly because when the crimped portion 1a had a gentle edge shape with a radius of 0.5 mm or more, there was no hang-up to the battery loading section 201 but, when the crimped portion 1a had a sharp edge shape with a smaller radius than 0.5 mm, there was a hang-up to the battery loading section 201 and the hang-up caused damages on the exterior label 8.

In view of increasing a capacity of a battery, a volume of a sealing portion of the battery is preferably small. To achieve this, the radius of the arc of the crimped portion 1a is preferably 1.5 mm or less. Furthermore, in view of making the exterior label 8 in close contact with the battery case 1 and thereby coating the battery case 1 with the exterior label 8, the radius of the arc of the crimped portion 1a is preferably 1.5 mm or less.

Next, for batteries including crimped portions 1a having an arc radius in the range in which damages on the exterior label 8 were not caused, states in loading each of the batteries in a device and discharge property were evaluated.

In the evaluation, 100 AA cell alkaline dry batteries were formed for each of examples (Working Examples 5 through 10 and Comparative Examples 1 through 3). In each of the batteries, a radius of the crimped portion 1a was 1.0 mm and a thickness of a sidewall of the battery case 1 was 0.18 mm. As shown in Table 2, an outer diameter R of the battery case 1 and a thickness T of the exterior label 8 were set differently for the batteries. Then, for the obtained batteries, states in loading each of the batteries n a device and discharge property were evaluated. Note that the battery of Working Example 3 in Table 2 is the same battery shown as Working Example 3 in Table 1.

TABLE 2

| | | | AA cell alkaline dry battery | | | |
|---|---|---|---|---|---|---|
| | | | | | | Discharge |
| | | | | | | property |
| | Battery case | | Outer | | | ANS |
| | Outer | Exterior label | Diameter | State in | Inner | Standard |
| | diameter R | Thickness T | R + 3T | loading in | Volume | C18.1M |
| | (mm) | (mm) | (mm) | device | ratio | (cycle) |
| Comparative Example 1 | 13.90 | 0.08 | 14.14 | Could be | 1.000 | 100 |
| Working Example 5 | 13.95 | 0.08 | 14.19 | loaded in | 1.007 | 102 |
| Working Example 6 | 14.00 | 0.08 | 14.24 | all kinds | 1.015 | 104 |
| Working Example 7 | 14.05 | 0.08 | 14.29 | of devices | 1.022 | 107 |
| Working Example 8 | 14.10 | 0.08 | 14.34 | | 1.030 | 111 |
| Working Example 9 | 14.05 | 0.10 | 14.35 | | 1.022 | 107 |
| Comparative Example 2 | 14.15 | 0.08 | 14.39 | Could not | 1.037 | |
| | | | | be loaded | | |
| | | | | in some | | |
| | | | | of devices | | |
| Working Example 10 | 14.15 | 0.05 | 14.30 | Could be | 1.037 | 116 |
| Working Example 3 | 14.20 | 0.05 | 14.35 | loaded in | 1.045 | 119 |
| | | | | all kinds | | |
| | | | | of devices | | |
| Comparative Example 3 | 14.25 | 0.05 | 14.40 | Could not | 1.052 | |
| | | | | be loaded | | |
| | | | | in some | | |
| | | | | of devices | | |

Table 2 shows results of the evaluation. As for the respective inner volume ratios in Table 2, respective inner volumes of battery cases 1 of the working examples were indicated relative to the inner volume ratio of Comparative Example 1 as a standard. The respective inner volume ratios were calculated from respective inner cross section areas of the battery cases 1. The cross section areas were calculated from outer diameters R and thicknesses of sidewall of the battery cases 1. Discharge properties shown in Table 2 were obtained by performing a discharge test in accordance with a method defined by the ANSI standard C18.1M. Assuming that a pulse discharge in which at a constant temperature of 21±2° C., the batteries were discharged at 1.5 W for 2 seconds and then were discharged at 0.65 W for 28 seconds was one cycle, for each of the examples, a discharge test was performed using 5 alkaline dry batteries for 10 cycles per hour until the voltage of the battery reached 1.05 V. Then, the accumulated cycle number was measured and the average value thereof was calculated.

As shown in Table 2, when the outer diameter (R+3T) of a battery was 14.35 mm or less, the battery could be loaded in all kinds of devices. In contrast, when the outer diameter of a battery was larger than 14.35 mm (Comparative Examples 2 and 3), the battery could not be loaded in some of the devices.

When the outer diameter of a battery was set to be 14.35 mm (the outer diameter R of a battery case was set to be 14.20 mm and the thickness T of an exterior label was set to be 0.05 mm) (Working Example 3), the inner volume of a battery could be increased by about 5%, compared to Comparative Example 1 corresponding to the outer diameter (14.15 mm) of a known battery. Furthermore, the discharge property could be improved by about 20%. This implies that, in addition to increase in inner volume, increase in electrode area contributed to the improvement.

If the thickness of the exterior label 8 is 0.05 mm or less, the mechanical strength is not enough and the exterior label 8 is easy to be broken. If the thickness of the exterior label 8 is larger than 0.10 mm, the mechanical strength is enough but, because of restrictions to the outer diameter of AA cell batteries, the outer diameter R of the battery case 1 becomes small, so that the effect of increase in capacity is reduced. Accordingly, the thickness of the exterior label 8 is preferably in the range from 0.05 mm to 0.10 mm.

As has been described, by setting the thickness of an exterior label to be in the range from 0.05 mm to 0.10 mm and the maximum outer diameter of a battery to be in the range from 14.20 mm to 14.35 mm, an AA cell battery which is practically loadable in an electronic device and has an increased capacity can be achieved. Furthermore, by setting the radius of a crimped portion to be in the range from 0.5 mm to 1.5 mm, damages on the external label caused in loading a battery in a device can be prevented, so that an AA cell battery which is capable of maintaining safety and has an increased capacity can be achieved.

The present invention has been explained using preferred embodiments. The description above does not limit the present invention and various modifications of the embodiments are, of course, possible. For example, in the above-described embodiments, the alkaline dry batteries have been explained. However, depending on selection of materials for electric power generation elements included in the battery case 1, the present invention can be, of course, applied to AA cell manganese dry batteries, lithium batteries, nickel hydride storage batteries and the like. Moreover, in the description above, the battery case was configured so as to also serve as one of the electrode terminals. However, a configuration in which an electrode terminal is united with a base portion (flat base) of a battery case by welding or the like may be adopted.

### INDUSTRIAL APPLICABILITY

The present invention is preferably used as a safe and high capacity AA cell battery for power supply for all sorts of devices.

1. An AA cell battery in which electric power elements are included in a cylindrical battery case with a base, an opening portion of the battery case is sealed with an external terminal plate with an insulating sealing body interposed therebetween, and an outer surface of the battery case is coated with an insulating exterior label,
wherein a thickness of the exterior label is in a range from 0.05 mm to 0.10 mm and a maximum outer diameter of the battery is in a range from 14.20 mm to 14.35 mm.

2. The AA cell battery of claim 1, wherein the opening portion of the battery case is sealed with the external terminal plate by inwardly bending an opening edge portion of the battery case into an arc shape to crimp the battery, and
a radius of an arc of the crimped portion is in a range from 0.5 mm to 1.5 mm.

3. The AA cell battery of claim 1 or claim 2, wherein the battery is an alkaline dry battery.

4. The AA cell battery of claim 1, wherein the battery case also serves as one of electrode terminals and the external terminal plate serves as the other one of the electrode terminals.
